(19) United States
(12) Patent Application Publication
(10) Pub. No.: US 2003/0036915 A1
(43) Pub. Date: Feb. 20, 2003

(54) Method and computer system for quality assurance regarding the cleaning of a facility or the maintenance of devices or facilities

(75) Inventors: Eva Neumann, Krun (DE); Oswald Neumann, Krun (DE)

Correspondence Address: Pyle & Piontek, Suite 850, 221 N. LaSalle St., Chicago, IL, 60601, US

(73) Assignee: Neumann & Neumann, Projekt-und Beratungs GmbH, Krun (DE)

(21) Appl. No.: 10/068,046

(22) Filed: Feb. 5, 2002

(30) Foreign Application Priority Data
Dec. 20, 2001 (EP) 01 130 364.1
Aug. 14, 2001 (EP) 01 119 508.8

(51) Int. Cl. G06F 17/60

(52) U.S. Cl. 705/1

(57) ABSTRACT

In a method for quality assurance regarding the cleaning of a facility, a screen displays a plurality of positions of the facility that may each be in at least two states for which a respective field is displayed, the fields indicating the states are marked upon entries made by a user and after the fields of all positions have been marked said information is sent to a central computer. In the method for quality assurance regarding the maintenance of a device or a facility, a screen displays a plurality of maintenance positions of the device or facility that may each be in at least two maintenance states for which a respective field is displayed, the fields indicating the maintenance states are marked upon entries made by a user, and after the fields of all positions have been marked said information is sent to a central computer. The associated computer system preferably comprises a palm including a corresponding software.

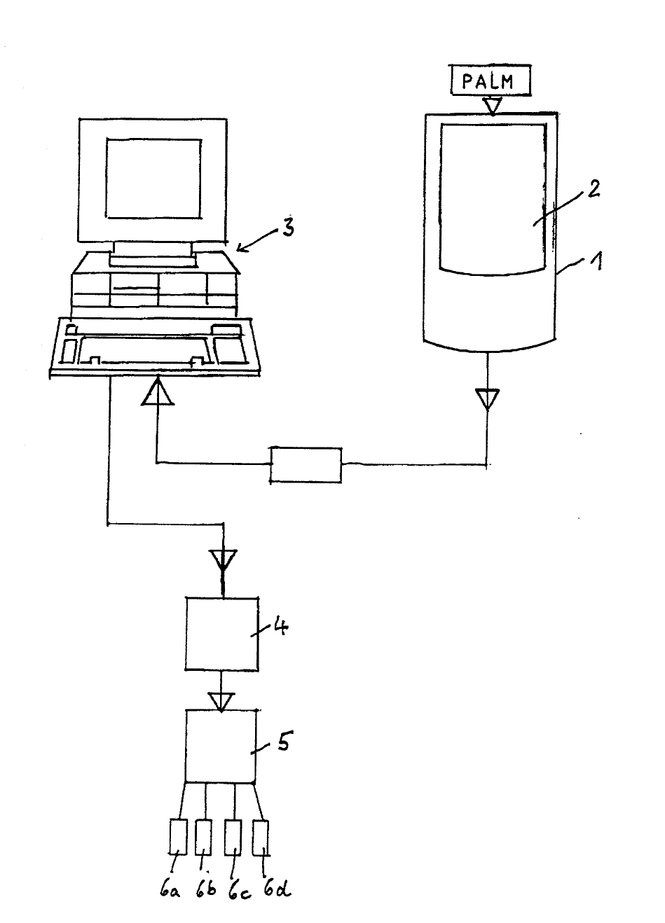

### BACKGROUND AND SUMMARY OF INVENTION

One aspect the present invention relates to a method for quality assurance regarding the cleaning of a facility, for example, the rooms of a building, a railroad car, or the like, and to a computer system for carrying out said method. The method is also suited for checking completion states other than the ones created by cleaning, for example, by security services that have to check whether specific devices are closed or in an operational state.

In the following, the invention will first be described in connection with quality assurance, and quality improvement rendered possible thereby, regarding the cleaning of facilities.

In many areas, such as office buildings, hotels, hospitals, retirement homes, there is a rising tendency to have the cleaning work performed by an independent contractor. This creates the problem that the work performed must be controlled efficiently to ensure a high quality standard of the cleaning process. This also requires a largely objective assessment of the work performed and a fast evaluation so that the faults found can be eliminated immediately.

This objective is not possible with the former standard procedure of inspecting the cleaning state of a facility merely visually.

According to a first aspect, it is the object of the present invention to provide a solution for the problem regarding quality assurance and quality improvement in cleaning processes carried out in and/or on a facility.

According to the method of the invention, a screen or display field of a computer displays a plurality of positions of the facility that may each be in at least two states for which a respective field is provided. Upon entries made by a user the fields that indicate the states found are marked, and after the fields of all positions have been marked, this information is transmitted to a receiver, preferably a central computer.

The at least two states of the individual positions are a perfect and an imperfect state, it being possible to provide also more than two states for each position.

The computer carried along by the user is preferably a palm recording device, which owing to its small dimensions, can be carried along comfortably. The user makes the entries by exerting pressure on the fields of the screen or display area of the palm.

Preferably, the screen of the computer should additionally indicate the respective date and time at which the check or control is made. This has, inter alia, the advantage that it can be documented when a cleaning supervisor was present at the site to be inspected.

Preferably, the central computer should evaluate the transmitted information such that it draws up a checklist or list of flaws which only contain the positions objected to, and optionally a quality report. The list of flaws can be printed via the transmitter system on a personal computer at the site of inspection.

As an addition and/or preferred embodiment, each field designating the states of the positions to be controlled should have assigned thereto in the software system a predetermined number of points and that the number of points achieved in the controlled cleaning process can be added up in a further step of the method. The quality of the cleaning operation can be determined in a highly objective way by comparison with the maximally achievable number of points.

Furthermore, inadequate or unsatisfactory states of one or several positions, such as a poorly cleaned washbasin or an area with cobwebs on a building ceiling, are sensed by an electronic camera which also indicates the associated date and time of the recording.

The method according to the invention permits an instant evaluation of the detected states of specific positions of a facility, or the like, so that a list of flaws can be drawn up immediately and the flaws can be remedied rapidly on the basis of the list, so that an adequate quality can be assured or an insufficient quality can be improved.

The computer system according to the invention for quality assurance regarding and transmitting the cleaning of a facility preferably contains a palm or hand held recording device which can be carried along and operated comfortably because of its small size within the system comprising software which on the display field or screen of the palm displays a plurality of positions of the facility which may each be in at least two states for which a respective field is displayed, and upon entries made by the user the fields indicating the states are marked, and comprising a transmitter which transmits the information entered into the palm to a central computer for evaluation.

With the computer system according to the invention it is possible to check the compartments of a sleeper train without spending excessive time to determine whether all of the cleaning operations have been carried out and whether all of the essential parts, such as lamps, are in working order. The data entered into the computer system are instantly evaluated, and a list of flaws can be drawn up for eliminating the detected flaws immediately. Upon application of the method according to the invention, the quality of a cleaning process can be detected and kept at the desired level.

A further aspect the invention relates to a method for quality assurance regarding the maintenance of devices or facilities, such as air conveying means, refrigerating systems, electric motors, drive elements or pipelines; this enumeration is only by way of example and does not limit the scope of the present invention.

In many areas of maintenance, this work is carried out by an independent contractor. This creates the problem that the maintenance work performed should be controlled efficiently to ensure a high quality standard of the maintenance process. This requires a largely objective assessment of the work performed and a fast evaluation so that the faults found can be eliminated immediately. This problem also arises frequently when maintenance work is carried out by in-house personnel.

Such a control is not possible with a merely visual inspection of the maintenance state of a device or facility.

According to a further aspect it is the object of the present invention to indicate a solution for the problem regarding quality assurance and quality improvement of maintenance measures taken on a device or a facility.

According to the method of the invention, a screen or display field of a computer displays a plurality of maintenance positions of a device or a facility that may each be in at least two maintenance states for which a respective field is provide. Upon entries made by the user the fields indicating the maintenance states found are marked and, after the fields of all positions have been marked, this information is transmitted to a receiver, preferably a central computer.

With the computer system according to the invention it is possible to check the following maintenance work in an efficient way:

a) Maintenance of air conveying means:

checking fans as to soiling, damage, corrosion, and attachment;

checking impeller as to unbalance;

checking blade adjusting device as to function;

checking bearing as to noise;

lubricating bearing;

checking flexible connection as to tightness;

checking vibration damper as to function;

checking protective grating as to function;

checking twist controller as to function; and

checking drainage as to function.

b) Maintenance of refrigerating systems:

checking industrial manometer of the compressor as to display accuracy;

measuring the temperature;

measuring evaporation temperature on the evaporator;

measuring suction gas temperature in front of the compressor;

measuring compression end pressure;

measuring compression and temperatures;

checking oil level on the inspection glass;

checking oil as to acid content;

measuring oil pressure with manometer;

resetting oil pressure;

checking oil pressure difference switch as to function;

resetting oil pressure difference switch;

measuring oil temperature in front of and after the oil cooler;

measuring water temperature in front of and after the oil cooler;

checking oil separator as to function;

checking crankcase bottom heating as to function;

checking start-up relief as to function; and

checking power controller as to function.

c) Maintenance of electric motors:

checking soiling, damage, corrosion, attachment and rotational direction;

checking bearing as to noise; and

lubricating, cleaning bearing.

d) Maintenance of drive elements:

checking belt drives as to soiling, damage, wear, tension and alignment;

resetting;

exchanging belts;

checking protective device as to damage, attachment and function; and

cleaning.

e) Maintenance of pipelines:

checking as to damage, tightness and attachment;

checking insulation as to damage (visual inspection);

checking thermometer as to damage;

checking manometer as to damage;

checking compensators as to damage (visual inspection);

checking liquid level;

refilling liquid;

checking safety device as to function; and

ventilating.

The data entered into the computer system are evaluated immediately; a list of flaws can here be drawn up for eliminating the detected flaws immediately. Upon application of the method according to the invention, the quality of a maintenance operation can be detected and kept at the desired level.

### Detailed Description and Description of the Drawings

The enclosed drawing shows a portable computer recording and transmitting device 1 with a display field 2 on which the respective cleaning states or maintenance states are marked successively. The device 1 is connected via a transmitter (not shown) to a computer 3 which evaluates the information transmitted and draws up a list of flaws 4 which can be sent automatically to one or more receivers, which is indicated by reference numerals 5 and 6a to 6d.

1. A method for quality assurance regarding the cleaning or maintenance of a facility, said method comprising the steps:
providing a visual display of a plurality of positions of the facility that may each be in at least two states for which a respective field is displayed;
entering the fields indicating the states are marked, and thereafter;
after the field of all positions have been marked, sending such information to a central computer.

2. The method according to claim 1, wherein the at least two states are a perfect state and an imperfect state.

3. The method according to claim 1, wherein the date and the time are displayed on the screen.

4. The method according to claim 1, wherein the entries are made by exerting pressure on the screen of a portable computer.

5. The method according to claim 1, wherein imperfect states are sensed by an electronic camera.

6. The method according to claim 1, wherein each field has assigned thereto a number of points and the number of points achieved are added up.

7. A computer system for quality assurance regarding the cleaning or maintenance of a facility, comprising;
a portable hand held device including a software system which on a screen displays a plurality of positions of the facility that may each be in at least two states for which a respective field is displayed, the fields indicating the states being marked upon entries made by a user.

8. The computer system according to claim 7, further comprising a transmitter which transmits the information stored in the device to a central computer for evaluation.
